(19) United States
(12) Patent Application Publication
(10) Pub. No.: US 2022/0385613 A1
(43) Pub. Date: Dec. 1, 2022

(54) MESSAGE REMINDING METHOD AND ELECTRONIC DEVICE

(71) Applicant: BEIJING DAJIA INTERNET INFORMATION TECHNOLOGY CO., LTD., Beijing (CN)

(72) Inventor: Shuo LIU, Beijing (CN)

(21) Appl. No.: 17/817,390

(22) Filed: Aug. 4, 2022

Related U.S. Application Data
(63) Continuation of application No. PCT/CN2021/076506, filed on Feb. 10, 2021.

(30) Foreign Application Priority Data
Feb. 14, 2020 (CN) 202010093487.8

(51) Int. Cl. H04L 51/224; G06F 3/0482; H04L 51/216; H04L 51/046

(52) U.S. Cl. CPC H04L 51/224; G06F 3/0482; H04L 51/216; H04L 51/046

(57) ABSTRACT

Disclosed are a method and apparatus for message reminding, an electronic device and a storage medium. The method comprises: acquiring a contact list of a currently logged-in target account; acquiring a conversation identifier set as being specially followed in the contact list, the conversation identifier including at least one of a contact identifier, a group identifier and an official account identifier; and displaying the conversation identifier in a form of a floating window.

### CROSS-REFERENCE

The present application is a continuation application of PCT Application No. PCT/CN2021/076506, entitled “MESSAGE REMINDING METHOD AND ELECTRONIC DEVICE” filed on Feb. 10, 2021, which is based on and claims the priority to the Chinese Patent Application NO. 202010093487.8, filed on Feb. 14, 2020, the entire contents of which are hereby incorporated by reference.

### TECHNICAL FIELD

The present disclosure relates to the field of communication technologies, and in particular, to a method and apparatus for message reminding, an electronic device and a storage medium.

### BACKGROUND

In the related art, in an Instant Messaging (IM) product, when one is browsing a message in a certain chat dialog box, if a message is received from another contact or group, a notification bar is usually popped up for notification.

### SUMMARY

The present disclosure provides a method and apparatus for message reminding, an electronic device and a storage medium.

According to an aspect of embodiments of the present disclosure, there is provided a method for message reminding, and the method includes: acquiring a contact list of a currently logged-in target account; acquiring a conversation identifier set as being specially followed in the contact list, wherein the conversation identifier includes at least one of a contact identifier and a group identifier; and displaying the conversation identifier in a form of a floating window.

According to another aspect of the embodiments of the present disclosure, there is provided an apparatus for message reminding, and the apparatus includes: a contact list acquisition module, configured to acquire a contact list of a currently logged-in target account; a specially-followed conversation acquisition module, configured to acquire a conversation identifier set as being specially followed in the contact list, wherein the conversation identifier includes at least one of a contact identifier and a group identifier; and a floating display module, configured to display the conversation identifier in a form of a floating window.

According to another aspect of the embodiments of the present disclosure, there is provided an electronic device, including: a processor; and a memory configured to store instructions executable by the processor; wherein, the processor is configured to execute the instructions to implement the method for message reminding described in any one of the foregoing embodiments.

According to another aspect of the embodiments of the present disclosure, there is provided a storage medium, wherein instructions in the storage medium, when being executed by a processor of an electronic device, cause the electronic device to perform the method for the message reminding described in any one of the foregoing embodiments.

According to another aspect of the embodiments of the present disclosure, there is provided a computer program product, wherein instructions in the storage medium, when being executed by a processor of an electronic device, cause the electronic device to perform the method for the message reminding described in any one of the foregoing embodiments.

### BRIEF DESCRIPTION OF THE DRAWINGS

FIG. 1 is a flowchart showing a method for message reminding according to an exemplary embodiment.

FIG. 2 is a flowchart showing another method for message reminding according to an exemplary embodiment.

FIG. 2A is a schematic diagram showing a display effect of a floating window according to an exemplary embodiment.

FIG. 2B is a schematic diagram showing another display effect of a floating window according to an exemplary embodiment.

FIG. 3 is a block diagram showing an apparatus for message reminding according to an exemplary embodiment.

FIG. 4 is a block diagram showing another apparatus for message reminding according to an exemplary embodiment.

FIG. 5 is a schematic structural diagram showing an electronic device according to an exemplary embodiment.

FIG. 6 is a block diagram showing another apparatus according to an exemplary embodiment.

### DETAILED DESCRIPTION

In order to make a person skilled in the art better understand the technical solutions of the present disclosure, the technical solutions in embodiments of the present disclosure will be clearly and completely described below with reference to the accompanying drawings.

It should be noted that in the present specification, the claims, and the accompanying drawings of the present disclosure, the terms “first”, “second”, and so on are intended to distinguish between similar objects but do not necessarily indicate a specific order or sequence. It is to be understood that data termed in such way is interchangeable in proper circumstances, so that the embodiments of the present disclosure described herein may be implemented in other sequences than the sequence illustrated or described herein. The implementations set forth in the following description of the exemplary embodiments do not represent all implementations consistent with the present disclosure. Rather, they are merely examples of devices and methods consistent with some aspects of the present disclosure as recited in the appended claims.

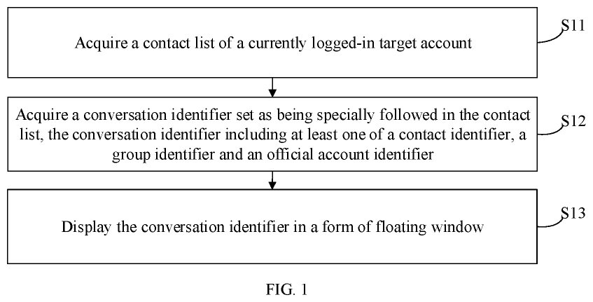

FIG. 1 is a flowchart showing a method for message reminding according to an exemplary embodiment. As shown in FIG. 1, the method for message reminding can be performed by an electronic device such as a mobile phone, a notebook, and a computer, and the method includes S11, S12 and S13.

In S11, a contact list of a currently logged-in target account is acquired.

In S12, a conversation identifier set as being specially followed in the contact list is acquired, where the conversation identifier includes at least one of a contact identifier, a group identifier and an official account identifier.

In S13, the conversation identifier is displayed in a form of a floating window.

This solution provides a way to display the conversation identifier by means of the floating window so as to simplify the interference from a message pop-up window when one stays at a third-party conversation page, and to remind of unread messages by marking the number of unread messages in the floating window. Moreover, in the embodiments of the present disclosure, the user can set or adjust the specially-followed conversation identifier in the contact list in advance according to requirements, and after the target account is successfully logged in, the contact list of the currently logged-in target account can be acquired, and the conversation identifier set as being specially followed in the contact list can be acquired.

In the embodiments of the present disclosure, the contact list of the currently logged-in target account is acquired, the conversation identifier set as being specially followed in the contact list is acquired, the conversation identifier includes at least one of a contact identifier, a group identifier and an official account identifier, and the conversation identifier is displayed in the form of the floating window. Therefore, interference from a message pop-up window can be reduced while the message reminding is performed.

The contact list may include, but is not limited to, the contact identifier of the corresponding target account, the group identifier of a chat group which the corresponding target account joins, the identifier of the official account followed by the target account, or the like. In this case, the conversation identifier set as being specially followed may be at least one of the contact identifier, the group identifier, and the official account identifier. The term of “at least one of the contact identifier, the group identifier, and the official account identifier” as used here refers to that the conversation identifier is only the contact identifier, only the group identifier, only the official account identifier, both the contact identifier and the group identifier, both the group identifier and the official account identifier, both the contact identifier and and the official account identifier, all of the contact identifier, the group identifier, and the official account identifier, or variations thereof.

It is to be noted that, if new content can be added to the contact list in future application process, the content contained in the conversation identifier can also be adjusted accordingly, which is not limited by the embodiments of the present invention. Moreover, the conversation identifier can be any identifier that can characterize an identity of a conversation, for example, the conversation identifier may be a name or nickname corresponding to the conversation, a user avatar corresponding to the conversation, or the like. Moreover, if the conversation identifier is the contact identifier, the conversation identifier in this case may be a contact name, a contact avatar, or the like. If the conversation identifier is the group identifier, the conversation identifier in this case may be a group name, a group avatar, or the like. If the conversation identifier is the official account identifier, the conversation identifier in this case may be an official account name, an official account avatar, or the like. Moreover, in the embodiments of the present disclosure, the user may set the specially-followed conversation identifier in any possible manner, which is not limited by the embodiments of the present disclosure.

In response to acquiring the conversation identifier set as being specially followed in the contact list of the currently logged-in target account, the conversation identifier set as being specially followed can be displayed in the form of the floating window, and the number of unread messages associated with the corresponding conversation identifier is displayed in the floating window. Parameters of the floating window such as a display position and appearance can be preset according to requirements, which are not limited by the embodiments of the present disclosure. Moreover, in the embodiments of the present disclosure, the appearance, the display position and the like of the floating window can also be adjusted during the display process of the floating window, which is not limited by the embodiments of the present disclosure.

For example, it is assumed that a user B is the specially-followed conversation identifier in the contact list of the target account, when the specially-followed conversation identifier is displayed in the form of the floating window, a floating window of the user B's avatar can be automatically generated and automatically arranged at a right side of the screen.

Moreover, the conversation identifier displayed in the form of the floating window may not disappear thereafter when it switches to any conversation page. Note that, in the embodiments of the present disclosure, if the user adjusts the conversation identifier set as being specially followed, the displayed floating window can be adjusted accordingly. For example, for the floating window of the user B's avatar as mentioned above, the avatar floating window can disappear by operations of long-pressing the conversation identifier of the user B and then selecting “unfollow and cancel floating”.

In addition, in the embodiments of the present disclosure, in order to prompt a message situation of the specially-followed conversation identifier, the number of unread messages associated with the conversation identifier currently displayed in a floating manner may also be displayed in the floating window. A display form of the number of unread messages in the floating window can be customized according to requirements, which is not limited by the embodiments of the present disclosure.

For example, the number of unread messages for each conversation identifier can be displayed in a form of a superscript at an upper right corner of the corresponding conversation identifier in the floating window. Moreover, if the number of unread messages for a certain conversation identifier is zero, the number of unread messages may not be displayed.

For example, for the above conversation identifier B, that is, the user identifier B, in a case where it switches to a conversation page where the target account and a user C chat, if the user B sends one or more messages in this case, the number of unread messages sent by the user B can be automatically displayed in the form of superscript in the floating window that is displaying the conversation identifier B, which will not disturb the chat between the target account and the user C, and will not affect reading the chat messages in the conversation page with user C by the user.

In addition, in practical applications, the unread messages of all contacts including the user identifier set as being specially followed may have been displayed in some display interfaces such as a message list page. Therefore, in the embodiments of the present disclosure, it is also possible to set such that the conversation identifier set as being specially followed and the number of unread messages thereof are displayed in the form of the floating window in only part of the interfaces according to requirements. For example, the conversation identifier set as being specially followed and the number of unread messages thereof may be displayed in the form of floating window on any conversation page and/or the contact list page, etc.

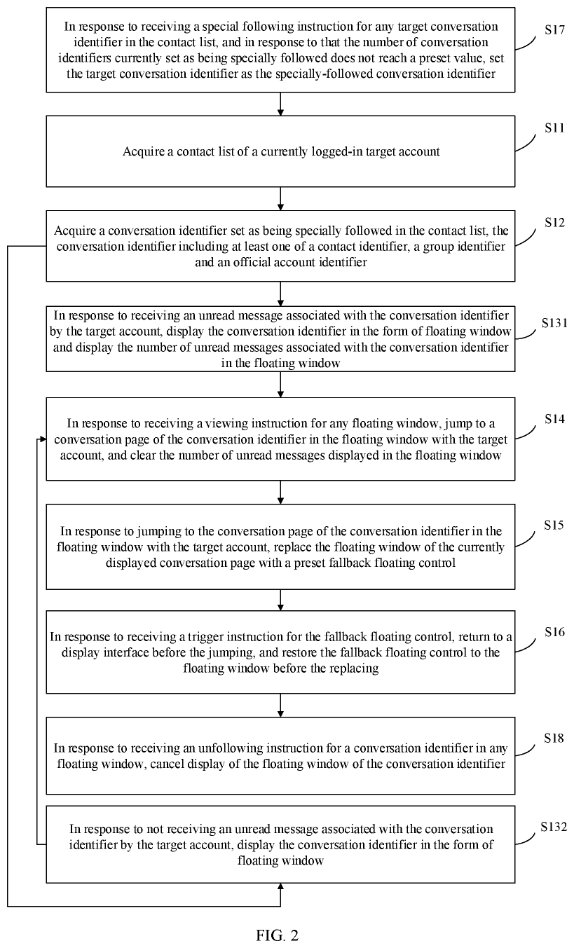

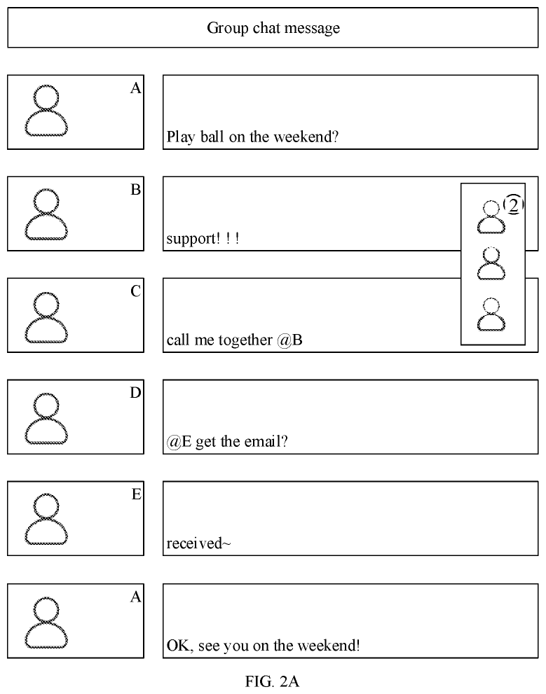

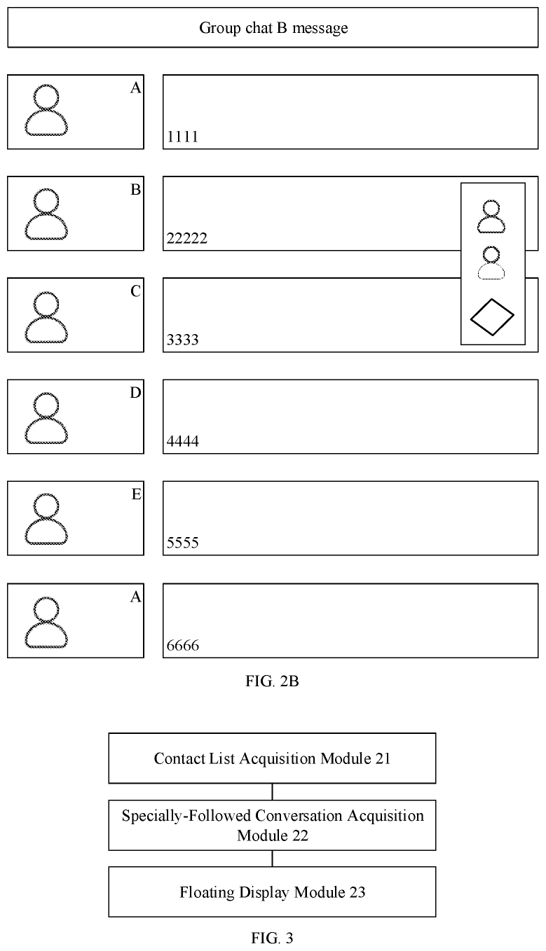

In the embodiments of the present disclosure, only one conversation identifier may be set as being specially followed, or multiple conversation identifiers may be set as being specially followed, which is not limited by the embodiments of the present disclosure. For example, if three conversation identifiers are set as being specially followed, multiple floating windows of the specially-followed conversation identifiers can be stitched together vertically and displayed in a line, and automatically floated at the far right of the screen, as shown in FIG. 2A. The user currently sets three specially-followed conversation identifiers, and when the user is chatting in an unfollowed group, if another specially followed group B sends two unread messages, the number of unread messages associated with the conversation identifier in the top floating window is 2.

In the embodiments of the present disclosure, the contact list of the currently logged-in target account is acquired, the conversation identifier set as being specially followed in the contact list is acquired, the conversation identifier including at least one of a contact identifier, a group identifier and an official account identifier, the conversation identifier is displayed in the form of the floating window, and the number of unread messages associated with the conversation identifier is displayed in the floating window. Therefore, interference from a message pop-up window can be reduced while the message reminding is performed.

Referring to FIG. 2, in the embodiments of the present disclosure, the method may further include: in S131, in response to receiving an unread message associated with the conversation identifier by the target account, displaying the number of unread messages associated with the conversation identifier in the floating window; and/or in S132, in response to not receiving the unread message associated with the conversation identifier by the target account, displaying the conversation identifier in the form of floating window.

In the embodiments of the present disclosure, the main significance of displaying the conversation identifier in the floating manner is to remind of the unread message, so as to prompt the user to view the message in time without affecting the user's current conversation. If there has been no new message generated for the conversation identifier set as being specially followed, the floating display thereof can be temporarily suspended, and instead, the conversation identifier with the unread message will be displayed as a priority.

In this case, it can detect whether the target account has received the unread message associated with each conversation identifier set as being specially followed. If the target account receives the unread message associated with each conversation identifier set as being specially followed, the conversation identifier is displayed in the form of the floating window, and the number of unread messages associated with the conversation identifier is displayed in the floating window. However, if the target account does not receive the unread message associated with each conversation identifier set as being specially followed, the corresponding conversation identifier may temporarily not be displayed in the floating manner.

Note that, in the embodiments of the present disclosure, when the user sets the specially-followed conversation identifier, the user may also consider the convenience of communication, and set the frequently contacted conversation identifier as the specially-followed conversation identifier. In this case, in order to facilitate the user to trigger entry into the conversation page of the conversation identifier set as being specially followed, the conversation identifier set as being specially followed is always displayed in the form of the floating window regardless of whether it has associated unread message. Moreover, if the number of unread messages associated with each floating window is displayed in each floating window, for a floating window with zero associated unread message, the number of unread messages displayed therein can be “0”, which is still easy to cause visual interference to the user to a certain extent, leading to mistakenly thinking that there are also unread messages for it and thus triggering to enter the conversation page corresponding to the corresponding floating window. Therefore, in the embodiments of the present disclosure, in order to avoid the above-mentioned interference, for the conversation identifier without the unread message, the number of unread messages associated with the corresponding conversation identifier may not be displayed in the floating window, and for the conversation identifier with the unread message, the number of unread messages associated with the corresponding conversation identifier can be displayed in the floating window to remind of the unread message, so as to facilitate the user to accurately distinguish whether the conversation identifier corresponding to the floating window has associated unread message.

Referring to FIG. 2, in the embodiments of the present disclosure, the method may further include: in S14, in response to receiving a viewing instruction for any floating window, jumping to a conversation page associated with the conversation identifier in the floating window, and clearing the number of unread messages displayed in the floating window. For example, when the conversation identifier is the contact identifier, the conversation page associated with the conversation identifier in the floating window can be a conversation page of a conversation between a contact identified by the contact identifier and the user corresponding to the target account. When the conversation identifier is the group identifier, the conversation page associated with the conversation identifier in the floating window can be a conversation page of a conversation in a group chat identified by the group identifier. When the conversation identifier is the official account identifier, the conversation page associated with the conversation identifier in the floating window can be a conversation page of a conversation between an official account identified by the official account identifier and the user corresponding to the target account.

In addition, in the embodiments of the present disclosure, in order to facilitate the user to timely and quickly jump to the conversation page associated with any conversation identifier set as being specially followed, it is also possible to set a shortcut in which it directly jumps to the conversation page through the floating window. In this case, if the viewing instruction for any floating window is received, it can jump to the conversation page associated with the conversation identifier in the corresponding floating window, and in this case, all the unread messages corresponding to the corresponding conversation identifier can be displayed on the conversation page, that is, the messages for the currently viewed conversation identifier are all read, and the number of unread messages is zero, and thus the number of unread messages displayed in the corresponding floating window can be cleared.

The viewing instruction for any floating window may be input in any possible manner, which is not limited by the embodiments of the present disclosure. For example, the viewing instruction for the corresponding floating window can be input by clicking on the floating window, and so on.

For example, for the above-mentioned user B, the user can click on the floating window corresponding to the conversation identifier of the user B at any time to input the viewing instruction for the floating window, and then directly jump to the conversation page of the target account with the user B. Moreover, in response to the user clicking the floating window, the client can automatically clear the superscript data of the unread message (that is, the number of unread messages displayed in the form of superscript) corresponding to the floating window.

For example, for the floating window shown in FIG. 2A, if the user clicks the floating window with the superscript of 2 to trigger the viewing instruction for the corresponding floating window, it can automatically jump to the conversation page with the group B.

Referring to FIG. 2, in the embodiments of the present disclosure, the method may further include: in S15, in response to jumping to the conversation page associated with the conversation identifier in the floating window, replacing the floating window of the currently displayed conversation identifier with a preset fallback floating control; and in S16, in response to receiving a trigger instruction for the fallback floating control, returning to a display interface before the jumping, and restoring the fallback floating control to the floating window before the replacing.

In addition, in the embodiments of the present disclosure, if the floating windows of multiple conversation identifiers are displayed at the same time, when the user clicks the floating window of any of the conversation identifiers, in order to facilitate prompting the user of the conversation identifier to which the currently displayed conversation page belongs, in response to jumping to the conversation page associated with the conversation identifier in the floating window, the floating window of the currently displayed conversation identifier may also be replaced by the preset fallback floating control.

Moreover, if the trigger instruction for the corresponding fallback floating control is received, it can return to the display interface before the jumping again, and the corresponding fallback floating control is restored to the floating window before the replacement.

A specific form of the fallback floating control can be customized according to requirements, which is not limited by the embodiments of the present disclosure. Moreover, in the embodiments of the present disclosure, the trigger instruction for the fallback floating control may be input in any possible method, which is not limited by the embodiments of the present disclosure.

For example, for the above-mentioned user B, if it jumps to the conversation page of the target account with the user B, the floating window corresponding to the conversation identifier of the user B can be automatically replaced with the fallback floating control. Assuming that the trigger instruction for the corresponding fallback floating control is input by clicking the fallback floating control, it can immediately return to the display interface before this jumping, and at the same time, the fallback floating control will be replaced by the floating window showing the user B again. Assuming that in this jumping it jumps from the conversation page of the target account with the user C to the conversation page of the target account with the user B, then it can return to the conversation page of the target account with the user C.

Note that, in the embodiments of the present disclosure, it may also be set to not directly return to the display interface before the jumping, but to return to a preset display interface, in response to receiving the trigger instruction for the fallback floating control. The preset display interface may be preset according to requirements, which is not limited by the embodiments of the present disclosure. For example, the preset display interface may be set as the contact list page, the message list page, or the like.

For example, for the floating window shown in FIG. 2A, if the user clicks the floating window with the superscript of 2 to trigger the viewing instruction for the corresponding floating window, it can automatically jump to the conversation page with the group B. In this case, the floating window of the group B can be automatically hidden and replaced with the fallback floating control, as shown in FIG. 2B, where the fallback floating control can be represented by a symbol “O”. Moreover, it can quickly fall back to the group chat page before the jumping through the fallback floating control.

Referring to FIG. 2, in the embodiments of the present disclosure, the method may further include: in S17, in response to receiving a special following instruction for any target conversation identifier in the contact list, and in response to that the number of conversation identifiers currently set as being specially followed does not reach a preset value, setting the target conversation identifier as a specially-followed conversation identifier.

In the embodiments of the present disclosure, the number of conversation identifiers that can be set as being specially followed is not greater than the preset value. A specific value of the preset value can be customized according to requirements, which is not limited by the embodiments of the present disclosure.

When setting the specially-followed conversation identifier, if the special following instruction for any target conversation identifier in the contact list is received, it can detect whether the number of conversation identifiers currently set as being specially followed reaches the preset value. If the number of conversation identifiers currently set as being specially followed does not reach the preset value, the target conversation identifier can be set as the specially-followed conversation identifier. If the number of conversation identifiers currently set as being specially followed reaches the preset value, the user can be prompted that the number of specially-followed conversation identifiers has reached an upper limit, and the user can choose to cancel any of the specially-followed conversation identifiers and then reset a new specially-followed conversation identifier.

The user may input the special following instruction for any target conversation identifier in the contact list in any possible manner, which is not limited by the embodiments of the present disclosure. For example, the special following instruction for the corresponding target conversation identifier can be triggered by selecting the target conversation identifier and right-clicking, and selecting a “follow and float” option in a pop-up function menu, as mentioned above. If the number of conversation identifiers currently set as being specially followed does not reach the preset value, the target conversation identifier can be directly set as the specially-followed conversation identifier.

Referring to FIG. 2, in the embodiments of the present disclosure, the method may further include: in S18, in response to receiving an unfollowing instruction for a conversation identifier in any floating window, canceling display of the floating window of the conversation identifier.

However, if the unfollowing instruction for any conversation identifier that has been set as being specially followed, that is, the conversation identifier in any floating window, is received, the special following of the corresponding conversation identifier can be canceled, and the floating window of the corresponding conversation identifier can be canceled at the same time.

The unfollowing instruction for the conversation identifier in any floating window may be input in any possible manner, which is not limited by the embodiments of the present disclosure. For example, the unfollowing instruction for the corresponding target conversation identifier can be triggered by selecting the conversation identifier in the contact list or the conversation identifier in the floating window, right-clicking, and selecting an “unfollow and cancel floating” option in the pop-up function menu.

For example, in the embodiments of the present disclosure, the specially-followed conversation identifier in the contact list of the target account can be set or canceled through the following server protocol:

```
  message SetFollowRequest {
      int64 uid = user1; // where uid is a target account
  bool follow = 1; // follow indicates setting or canceling of the special following. For
example, when a value of follow is set to 1, the special following is set, and when the value of
follow is 0, the special following is canceled
  int64 target_uid = XXX; // target_uid is any conversation identifier selected by a user in
the contact list for which the special following is set or canceled
  }
  message SetFollowResponse {
    bool success = 1; // success indicates whether the setting or canceling of the special
following is successful. For example, a value of success can be set to 1 to indicate success, and
0 to indicate failure
  }
```

In some embodiments, it is assumed that the user corresponding to the target account selects any conversation identifier in the contact list to set or cancel the special following, and in this case, the uid in the above codes can be assigned the target account, and target_uid is assigned the conversation identifier selected by the user, and the specific value of “follow” is determined according to whether the special following is set or cancelled by the user. The special following is realized or canceled by running the SetFollowRequest function, and whether the setting or canceling of the special following is successful or not is obtained through an output result of “success”.

In addition, in a storage layer, the server can store a list of specially-followed conversation identifiers set by the user corresponding to the target account in a database. A table structure can be as follows:

```
  create table follows(
  id bigint auto_increment primary key, // primary key
  uid bigint not null, // target account
  target_uid bigint not null, // any conversation identifier set as being specially followed in
the contacts of the target account
  target_type int not null, // target_type represents a conversation type, for example, it can
be set as 0 to represent a private chat and set as 1 to represent a group chat
  create_time timestamp not null, // table creation time
  update_time timestamp not null // table update time
  )
```

In some embodiments, the specially-followed conversation identifier of each target account can be recorded with the above table structure in the server, so that it is convenient for the client to look up the specially-followed conversation identifier corresponding to the current target account.

The protocol can be passed between the client and the server, the client makes a request, and the server responds to the client's request. Whenever a user logs in, the list of conversation identifiers that have been set as being specially followed will be automatically pulled, and the client can cache a copy of the pulled results in local, and automatically display the floating window of the conversation identifier set as being specially followed when necessary. Moreover, push of a new message for the conversation identifier set as being specially followed will be automatically received by the client and displayed in the numerical superscript in the floating window. In addition, if a certain conversation identifier that has been set as being specially followed is deleted from the contact list by the target user, the floating window of the corresponding conversation identifier will also be deleted accordingly.

In the embodiments of the present disclosure, in response to the target account receiving the unread message associated with the conversation identifier, the conversation identifier is displayed in the form of floating window, and the number of unread messages associated with the conversation identifier is displayed in the floating window; and/or, in response to the target account not receiving the unread message associated with the conversation identifier, the conversation identifier is displayed in the form of floating window. Therefore, according to requirements, only the floating window with the unread message can be displayed, or only the floating window can be displayed for the conversation identifier that has not received the unread message, thereby further reducing the visual interference from the message pop-up window.

Moreover, in the embodiments of the present disclosure, in response to receiving the viewing instruction for any floating window, it jumps to the conversation page of the conversation identifier in the floating window with the target account, and the number of unread messages displayed in the floating window is cleared. In addition, in response to jumping to the conversation page of the conversation identifier in the floating window with the target account, the floating window of the currently displayed conversation page is replaced by the preset fallback floating control; and in response to receiving the trigger instruction for the fallback floating control, it returns to the display interface before the jumping, and the fallback floating control is restored to the floating window before the replacement. In this way, fast jumping and jumping back can be realized, which is convenient for fast switching between multiple conversations, and it can enter the conversation page of the specially-followed conversation identifier through one-click operation anytime and anywhere, without having to go back to the list page and click again to enter, which is simple and efficient.

In addition, in the embodiments of the present disclosure, in response to receiving the special following instruction for any target conversation identifier in the contact list, and in response to that the number of conversation identifiers currently set as being specially followed does not reach the preset value, the target conversation identifier can be set as the specially-followed conversation identifier. In addition, in response to receiving the unfollowing instruction for the conversation identifier in any floating window, the display of the floating window of the conversation identifier is canceled. Therefore, the specially-followed conversation identifier can be set or adjusted according to actual needs, and there is a certain limitation on the number of conversation identifiers set as being specially followed, so as to meet the following needs of the user while avoiding visual interference caused by too many floating windows.

FIG. 3 is a block diagram showing an apparatus for message reminding according to an exemplary embodiment. Referring to FIG. 3, the apparatus includes a contact list acquisition module 21, a specially-followed conversation acquisition module 22 and a floating display module 23.

The contact list acquisition module 21 is configured to acquire a contact list of a currently logged-in target account;

the specially-followed conversation acquisition module 22 is configured to acquire a conversation identifier set as being specially followed in the contact list, where the conversation identifier includes at least one of a contact identifier, a group identifier and an official account identifier; and

the floating display module 23 is configured to display the conversation identifier in a form of floating window.

In the embodiments of the present disclosure, the contact list of the currently logged-in target account is acquired, the conversation identifier set as being specially followed in the contact list is acquired, the conversation identifier including at least one of a contact identifier, a group identifier and an official account identifier, the conversation identifier is displayed in the form of the floating window, and the number of unread messages associated with the conversation identifier is displayed in the floating window. Therefore, interference from a message pop-up window can be reduced while the message reminding is performed.

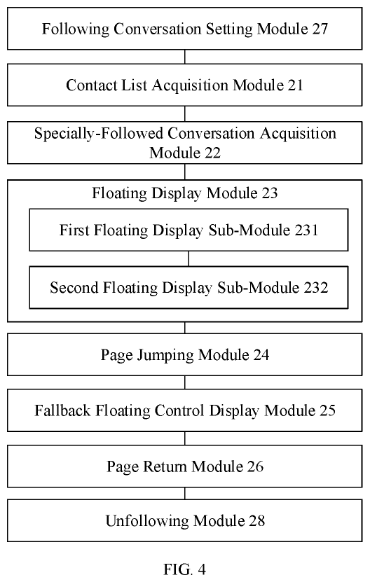

Referring to FIG. 4, in the embodiments of the present disclosure, the floating display module 23 may further include:

a first floating display sub-module 231, configured to display the number of unread messages associated with the conversation identifier in the floating window, in response to receiving an unread message associated with the conversation identifier by the target account; and/or,

a second floating display sub-module 232, configured to display he conversation identification in the form of floating window, in response to not receiving the unread message associated with the conversation identifier by the target account.

Referring to FIG. 4, in the embodiments of the present disclosure, the apparatus for the message reminding may further include:

a page jumping module 24, configured to in response to receiving a viewing instruction for any floating window, jump to a conversation page associated with the conversation identifier in the floating window, and clear the number of unread messages displayed in the floating window.

Referring to FIG. 4, in the embodiments of the present disclosure, the apparatus for the message reminding may further include:

a fallback floating control display module 25, configured to replace the floating window of the currently displayed conversation identifier with a preset fallback floating control, in response to jumping to the conversation page associated with the conversation identifier in the floating window; and

a page return module 26, configured to return to a display interface before the jumping, and restore the fallback floating control to the floating window before the replacing, in response to receiving a trigger instruction for the fallback floating control.

Referring to FIG. 4, in the embodiments of the present disclosure, the apparatus for the message reminding may further include:

a following conversation setting module 27, configured to in response to receiving a special following instruction for any target conversation identifier in the contact list, and in response to that the number of conversation identifiers currently set as being specially followed does not reach a preset value, set the target conversation identifier as a specially-followed conversation identifier.

Referring to FIG. 4, in the embodiments of the present disclosure, the apparatus for the message reminding may further include:

an unfollowing module 28, configured to in response to receiving an unfollowing instruction for an conversation identifier in any floating window, cancel display of the floating window of the conversation identifier.

In the embodiments of the present disclosure, in response to the target account receiving the unread message associated with the conversation identifier, the conversation identifier is displayed in the form of floating window, and the number of unread messages associated with the conversation identifier is displayed in the floating window. Therefore, only the floating window with the unread message can be displayed, thereby further reducing the visual interference from the message pop-up window.

Moreover, in the embodiments of the present disclosure, in response to receiving the viewing instruction for any floating window, it jumps to the conversation page of the conversation identifier in the floating window with the target account, and the number of unread messages displayed in the floating window is cleared. In addition, in response to jumping to the conversation page of the conversation identifier in the floating window with the target account, the floating window of the currently displayed conversation page is replaced by the preset fallback floating control; in response to receiving the trigger instruction for the fallback floating control, it returns to the display interface before the jumping, and the fallback floating control is restored to the floating window before replacement. In this way, fast jumping and jumping back can be realized, which is convenient for fast switching between multiple conversations, and it can enter the conversation page of the specially-followed conversation identifier through one click anytime and anywhere, without having to go back to the list page and click again to enter, which is simple and efficient.

In addition, in the embodiments of the present disclosure, in response to receiving the special following instruction for any target conversation identifier in the contact list, and in response to that the number of conversation identifiers currently set as being specially followed does not reach the preset value, the target conversation identifier can be set as the specially-followed conversation identifier. In addition, in response to receiving the unfollowing instruction for the conversation identifier in any floating window, the display of the floating window of the conversation identifier is canceled. Therefore, the specially-followed conversation identifier can be set or adjusted according to actual needs, and there is a certain limitation on the number of conversation identifiers set as being specially followed, so as to meet the following needs of the user while avoiding visual interference caused by too many floating windows.

Regarding the apparatus in the above-mentioned embodiments, a specific manner in which each module performs operations has been described in detail in the method embodiments and will not be described in detail here.

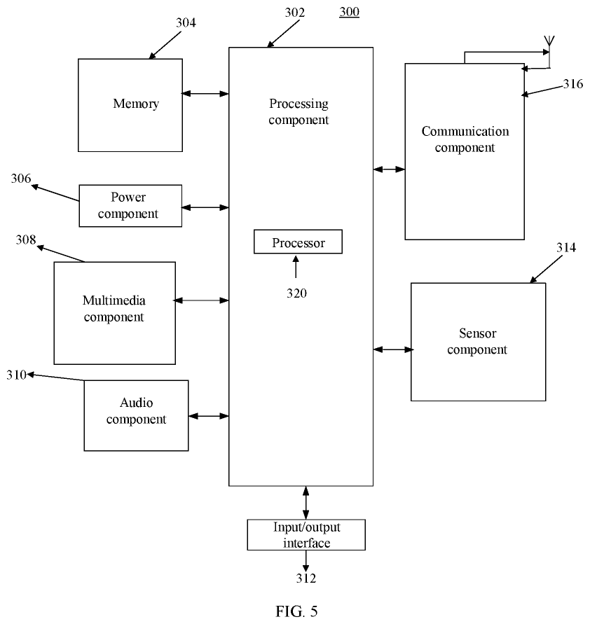

FIG. 5 is a schematic structural diagram of an electronic device 300 for message reminding according to an embodiment of the present disclosure. For example, the device 300 may be a mobile phone, a computer, a digital broadcast terminal, a messaging device, a game console, a tablet device, a medical device, a fitness device, a personal digital assistant, or the like.

Referring to FIG. 5, the device 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operations of the device 300, such as the operations associated with display, telephone calls, data communications, camera operations, and recording operations. The processing component 302 may include one or more processors 320 to execute instructions to perform all or part of the steps in the above described methods. Moreover, the processing component 302 may include one or more modules which facilitate interaction between the processing component 302 and other components. For instance, the processing component 302 may include a multimedia module to facilitate the interaction between the multimedia component 308 and the processing component 302. The processing component 302 is configured to execute instructions stored in the memory 304 to implement the steps described above.

The memory 304 is configured to store various types of data to support the operation of the device 300. Examples of such data include instructions for any applications or methods operated on the device 300, contact data, phonebook data, messages, pictures, video, etc. The memory 304 may be implemented using any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 306 provides power to various components of the device 300. The power component 306 may include a power management system, one or more power sources, and any other components associated with the generation, management, and distribution of power in the device 300.

The multimedia component 308 includes a screen providing an output interface between the device 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 308 includes a front camera and/or a rear camera. The front camera and the rear camera may receive an external multimedia datum while the device 300 is in an operation mode, such as a photographing mode or a video mode. Each of the front camera and the rear camera may be a fixed optical lens system or have focus and optical zoom capability.

The audio component 310 is configured to output and/or input audio signals. For example, the audio component 310 includes a microphone (MIC) configured to receive an external audio signal when the device 300 is in an operation mode, such as a call mode, a recording mode, and a voice recognition mode. The received audio signal may be further stored in the memory 304 or transmitted via the communication component 316. In some embodiments, the audio component 310 further includes a speaker to output audio signals.

The I/O interface 312 provides an interface between the processing component 302 and peripheral interface modules, such as a keyboard, a click wheel, buttons, and the like. The buttons may include, but are not limited to, a home button, a volume button, a starting button, and a locking button.

The sensor component 314 includes one or more sensors to provide status assessments of various aspects of the device 300. For instance, the sensor component 314 may detect an open/closed status of the device 300, relative positioning of components, e.g., the display and the keypad, of the device 300, a change in position of the device 300 or a component of the device 300, a presence or absence of user contact with the device 300, an orientation or an acceleration/deceleration of the device 300, and a change in temperature of the device 300. The sensor component 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an accelerometer sensor, a gyroscope sensor, a magnetic sensor, a pressure sensor, or a temperature sensor.

The communication component 316 is configured to facilitate wired or wireless communication between the device 300 and other apparatus. The electronic device 1100 may access a wireless network based on a communication standard, such as Wi-Fi, an operator network (e.g., 2G, 3G, 4G or 5G) or a combination thereof. In an embodiment, the communication component 316 receives a broadcast signal or broadcast associated information from an external broadcast management system via a broadcast channel. In an embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the device 300 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above described method.

In an embodiment of the present disclosure, there is also provided a storage medium including instructions, such as the memory 304 including instructions, the above instructions may be executed by the processor 320 in the device 300 for performing the above-described methods. In some embodiments, the storage medium may be a non-transitory computer-readable storage medium, and for example, the non-transitory computer-readable storage medium may be a ROM, a Random Access Memory (RAM), a CD-ROM, a magnetic tape, a floppy disc, an optical data storage device, and the like.

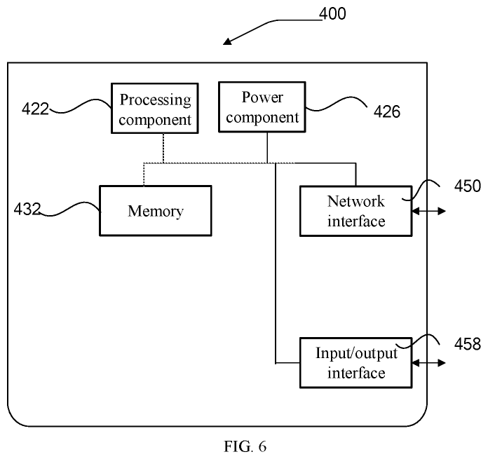

FIG. 6 is a block diagram showing an apparatus 400 for message reminding according to an embodiment of the present disclosure. For example, the apparatus 400 may be provided as a server. Referring to FIG. 6, the apparatus 400 includes a processing component 422, which further includes one or more processors and a memory resource represented by a memory 432 that is used for storing instructions executable by the processing component 422, such as an application program. The application program stored in the memory 432 may include one or more modules, each corresponding to a set of instructions. In addition, the processing component 422 is configured to execute the instructions to perform the method for the message reminding.

The apparatus 400 may also include: a power component 426 configured to perform power management of the apparatus 400, a wired or wireless network interface 450 configured to connect the apparatus 400 to the network, and an input/output (I/O) interface 458. The apparatus 400 may operate an operating system stored in the memory 432, such as Windows Server™, Mac OS X™, Unix™, Linux™, FreeBSD™, or the like.

Other embodiments of the present disclosure will be apparent to those skilled in the art from consideration of the specification and practice of the present disclosure disclosed here. The present disclosure is intended to cover any variations, uses, or adaptations of the present disclosure that follow the general principles of the present disclosure and include the common knowledge or conventional technical means in the technical field not disclosed in the present disclosure. The specification and embodiments are considered as exemplary only, and a true scope and spirit of the present disclosure is indicated by the appending claims.

What is claimed is:

1. A method for message reminding, comprising:
acquiring a contact list of a currently logged-in target account;
acquiring a conversation identifier set as being specially followed in the contact list, wherein the conversation identifier comprises at least one of a contact identifier, a group identifier and an official account identifier; and
displaying the conversation identifier in a form of floating window.

2. The method according to claim 1, further comprising:
in response to receiving an unread message associated with the conversation identifier by the target account, displaying the number of unread messages associated with the conversation identifier in the floating window.

3. The method according to claim 1, further comprising:
in response to receiving a viewing instruction for any floating window, jumping to a conversation page associated with the conversation identifier in the floating window, and clearing the number of unread messages displayed in the floating window.

4. The method according to claim 3, further comprising:
in response to jumping to the conversation page associated with the conversation identifier in the floating window, replacing the floating window of the currently displayed conversation identifier with a preset fallback floating control; and
in response to receiving a trigger instruction for the fallback floating control, returning to a display interface before the jumping, and restoring the fallback floating control to the floating window before the replacing.

5. The method according to claim 1, further comprising:
in response to receiving a special following instruction for any target conversation identifier in the contact list, and in response to that the number of conversation identifiers currently set as being specially followed does not reach a preset value, setting the target conversation identifier as a specially-followed conversation identifier.

6. The method according to claim 1, further comprising:
in response to receiving an unfollowing instruction for the conversation identifier in any floating window, canceling display of the floating window of the conversation identifier.

7. An electronic device, comprising:
a processor; and
a memory configured to store instructions executable by the processor;
wherein the processor is configured to execute the instructions to implement the following operations:
acquiring a contact list of a currently logged-in target account;
acquiring a conversation identifier set as being specially followed in the contact list, wherein the conversation identifier comprises at least one of a contact identifier, a group identifier and an official account identifier; and
displaying the conversation identifier in a form of floating window.

8. The electronic device according to claim 7, wherein the processor is configured to execute the instructions to implement the following operations:
in response to receiving an unread message associated with the conversation identifier by the target account, displaying the number of unread messages associated with the conversation identifier in the floating window.

9. The electronic device according to claim 7, wherein the processor is configured to execute the instructions to implement the following operations:
in response to receiving a viewing instruction for any floating window, jumping to a conversation page associated with the conversation identifier in the floating window, and clearing the number of unread messages displayed in the floating window.

10. The electronic device according to claim 9, wherein the processor is configured to execute the instructions to implement the following operations:
replacing the floating window of the currently displayed conversation identifier with a preset fallback floating control, in response to jumping to the conversation page associated with the conversation identifier in the floating window; and
returning to a display interface before the jumping and restoring the fallback floating control to the floating window before the replacing, in response to receiving a trigger instruction for the fallback floating control.

11. The electronic device according to claim 7, wherein the processor is configured to execute the instructions to implement the following operations:
in response to receiving a special following instruction for any target conversation identifier in the contact list, and in response to that the number of conversation identifiers currently set as being specially followed does not reach a preset value, setting the target conversation identifier as a specially-followed conversation identifier.

12. The electronic device according to claim 7, wherein the processor is configured to execute the instructions to implement the following operations:
in response to receiving an unfollowing instruction for the conversation identifier in any floating window, canceling display of the floating window of the conversation identifier.

13. A non-transitory computer-readable storage medium, wherein instructions in the storage medium, when being executed by a processor of an electronic device, cause the electronic device to implement the following operations:
acquiring a contact list of a currently logged-in target account;
acquiring a conversation identifier set as being specially followed in the contact list, wherein the conversation identifier comprises at least one of a contact identifier, a group identifier and an official account identifier; and
displaying the conversation identifier in a form of floating window.

14. The storage medium according to claim 13, wherein the instructions in the storage medium, when being executed by a processor of an electronic device, cause the electronic device to implement the following operations:
in response to receiving an unread message associated with the conversation identifier by the target account, displaying the number of unread messages associated with the conversation identifier in the floating window.

15. The storage medium according to claim 13, wherein the instructions in the storage medium, when being executed by a processor of an electronic device, cause the electronic device to implement the following operations:
in response to receiving a viewing instruction for any floating window, jumping to a conversation page associated with the conversation identifier in the floating window, and clearing the number of unread messages displayed in the floating window.

16. The storage medium according to claim 15, wherein the instructions in the storage medium, when being executed by a processor of an electronic device, cause the electronic device to implement the following operations:
replacing the floating window of the currently displayed conversation identifier with a preset fallback floating control, in response to jumping to the conversation page associated with the conversation identifier in the floating window; and
returning to a display interface before the jumping and restoring the fallback floating control to the floating window before the replacing, in response to receiving a trigger instruction for the fallback floating control.

17. The storage medium according to claim 13, wherein the instructions in the storage medium, when being executed by a processor of an electronic device, cause the electronic device to implement the following operations:
in response to receiving a special following instruction for any target conversation identifier in the contact list, and in response to that the number of conversation identifiers currently set as being specially followed does not reach a preset value, setting the target conversation identifier as a specially-followed conversation identifier.

18. The storage medium according to claim 13, wherein the instructions in the storage medium, when being executed by a processor of an electronic device, cause the electronic device to implement the following operations:
in response to receiving an unfollowing instruction for the conversation identifier in any floating window, canceling display of the floating window of the conversation identifier.
